(19) United States
(12) Patent Application Publication
(10) Pub. No.: US 2026/0162294 A1
(43) Pub. Date: Jun. 11, 2026

(54) SYSTEM AND PROGRAM

(71) Applicant: Sony Semiconductor Solutions Corporation, Kanagawa (JP)

(72) Inventor: Takaki Ueno, Kanagawa (JP)

(21) Appl. No.: 18/868,412

(22) PCT Filed: Jun. 26, 2023
(86) PCT No.: PCT/JP2023/023672

§ 371 Date: Nov. 22, 2024

(30) Foreign Application Priority Data
Jul. 5, 2022 (JP) 2022-108503

(51) Int. Cl. G06T 7/70; E02F 9/26; G06T 7/50; G06V 10/25; G06V 20/56

(52) U.S. Cl. CPC G06T 7/70; E02F 9/261; G06T 7/50; G06V 10/25; G06V 20/56; G06T 2207/10028; G06T 2207/20072; G06T 2207/30252; G06V 2201/07

(57) ABSTRACT

To reduce a processing time for detecting a cargo bed region. A system includes a correction unit, a proximity portion detection unit, and a housing portion detection unit. The correction unit corrects, in a distance image including a housing portion on which an object is placed by a work device, the distance image according to movement of the work device. The proximity portion detection unit detects a proximity portion of the housing portion based on a distance histogram generated from the corrected distance image. The housing portion detection unit detects the housing portion based on the detected proximity portion and the distance image.

### DESCRIPTION

### Field

The present disclosure relates to a system and a program.

### Background

Work of loading earth and sand or the like on a cargo bed of a dump truck or the like using an excavator is performed at a construction site or the like. At this time, since an arm of the excavator approaches the cargo bed, the arm and the cargo bed are likely to collide. In order to prevent such a collision accident, there has been proposed a system that acquires a captured image showing a target be loaded and unloaded of a conveyance object of a work machine such as an excavator and specifies at least one surface of the target to be loaded and unloaded (see, for example, Patent Literature 1).

### CITATION LIST

### Patent Literature

Patent Literature 1: JP 2020-126363 A

### SUMMARY

### Technical Problem

However, in the related art described above, since point cloud data of a cargo bed region is generated using a result of semantic segmentation, there is a problem in that a processing time is long.

Therefore, the present disclosure proposes a system and a program that reduce a processing time for detecting a cargo bed region.

### Solution to Problem

A system according to the present disclosure includes correction unit, a proximity portion detection unit and a housing portion detection unit. The correction unit corrects, in a distance image including a housing portion on which an object is placed by a work device, the distance image according to movement of the work device. The proximity portion detection unit detects a proximity portion of the housing portion based on a distance histogram generated from the corrected distance image. The housing portion detection unit detects the housing portion based on the detected proximity portion and the distance image.

Furthermore, a program according to the present disclosure includes: a procedure of correcting, in a distance image including a housing portion on which an object is placed by a work device, the distance image according to movement of the work device; a procedure of detecting a proximity portion of the housing portion based on a distance histogram generated from the corrected distance image; and a procedure of detecting the housing portion based on the detected proximity portion and the distance image.

### BRIEF DESCRIPTION OF DRAWINGS

FIG. 1 is a diagram illustrating a configuration example of a work device according to an embodiment of the present disclosure.

FIG. 2 is a diagram illustrating a configuration example of a detection device according to the embodiment of the present disclosure.

FIG. 3 is a diagram illustrating a configuration example of a cargo bed detection processing unit according to the embodiment of the present disclosure.

FIG. 4 is a diagram illustrating an example of a target region image according to the embodiment of the present disclosure.

FIG. 5A is a diagram illustrating an example of correction according to the embodiment of the present disclosure.

FIG. 5B is a diagram illustrating an example of correction according to the embodiment of the present disclosure.

FIG. 5C is a diagram illustrating an example of correction according to the embodiment of the present disclosure.

FIG. 6A is a diagram illustrating an example of detection of a cargo bed region according to the embodiment of the present disclosure.

FIG. 6B is a diagram illustrating an example of detection of a cargo bed region according to the embodiment of the present disclosure.

FIG. 6C is a diagram illustrating an example of detection of a cargo bed region according to the embodiment of the present disclosure.

FIG. 7 is a diagram illustrating an example of a processing procedure of cargo bed region detection processing according to the embodiment of the present disclosure.

### DESCRIPTION OF EMBODIMENTS

Embodiments of the present disclosure are explained in detail below with reference to the drawings.

### Configuration of a Work Device

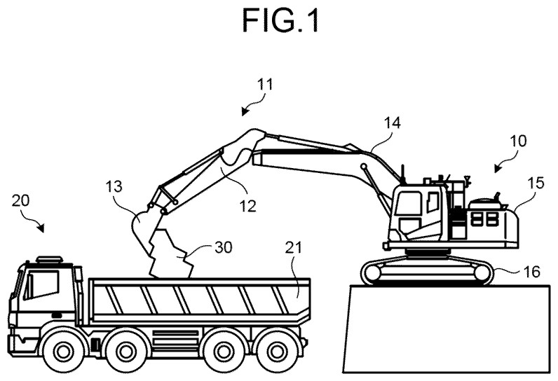

FIG. 1 is a diagram illustrating a configuration example of a work device according to an embodiment of the present disclosure. The figure assumes work of loading an object 30 such as earth and sand on a cargo bed 21 of a dump truck 20 using an excavator 10. A work device 11 illustrated in the figure is disposed on a turning body 15 of the excavator 10. The turning body 15 is supported by a traveling body 16.

The work device 11 includes a boom 14, an arm 12, and a bucket 13. The boom 14 is attached to the turning body 15. The arm 12 is attached to an end of the boom 14. The bucket 13 is attached to an end of the arm 12. The bucket 13 is a container that holds the object 30 such as earth and sand.

A procedure of work is explained. First, the bucket 13 scoops up and holds the object 30. Subsequently, in a state in which the object 30 is held by the bucket 13, the excavator 10 approaches the dump truck 20. At this time, the excavator 10 moves to the vicinity of the dump truck 20 with the traveling body 16 and moves the work device 11 to an upper part of the cargo bed 21 according to turning of the turning body 15. Thereafter, the excavator 10 operates the bucket 13 to place the object 30 on the cargo bed 21.

At the time of this work, since the arm 12 and the bucket 13 approach the cargo bed 21, it is likely that the arm 12 and the bucket 13 collide with the cargo bed 21. In particular, when the excavator 10 is remotely controlled, the likelihood of collision increases. Therefore, a detection device that detects the position of the cargo bed 21 from the side of the excavator 10 is disposed. With this detection device, the position of the cargo bed 21 can be grasped and an operator can be alerted. Note that the cargo bed 21 is an example of a housing portion described in the claims.

### Configuration of the Detection Device

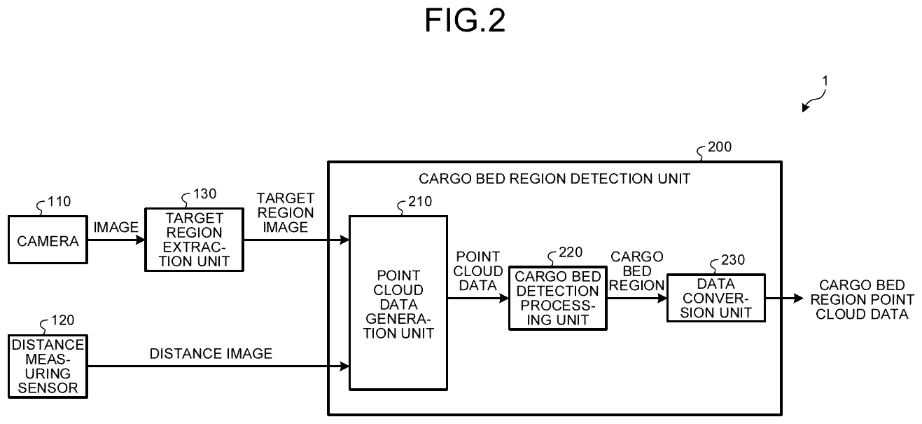

FIG. 2 is a diagram illustrating a configuration example of the detection device according to the embodiment of the present disclosure. The figure is a block diagram illustrating a configuration example of the detection device 1. The detection device 1 includes a camera 110, a distance measuring sensor 120, a target region extraction unit 130, and a cargo bed region detection unit 200. Note that the detection device 1 is an example of a system described in the claims.

The camera 110 is disposed at the front portion of the turning body 15 of the excavator 10 and generates an image of the vicinity of the work device 11. The camera 110 outputs the generated image to the target region extraction unit 130.

The target region extraction unit 130 extracts an image of a target region from the image output from the camera 110. An image of the excavator 10 corresponds to the target region. The target region extraction unit 130 retrieves, from the image, a region where the excavator 10 is imaged, processes the region into data of a bounding box, and outputs the data as an image of the target region. The region where the excavator 10 is imaged can be retrieved by, for example, AI (Artificial Intelligence). The target region extraction unit 130 outputs the target region image to a point cloud data generation unit 210 of the cargo bed region detection unit 200.

The distance measuring sensor 120 is disposed at the front portion of the turning body 15 of the excavator 10 and generates a distance image of the vicinity of the work device 11. This distance image is also referred to as depth map and is an image in which distance information is reflected for each pixel. The distance measuring sensor 120 outputs the generated distance image to the point cloud data generation unit 210 of the cargo bed region detection unit 200.

The cargo bed region detection unit 200 detects a cargo bed region based on the target region image and the distance image. The cargo bed region detection unit 200 includes the point cloud data generation unit 210, a cargo bed detection processing unit 220, and a data conversion unit 230.

The point cloud data generation unit 210 generates point cloud data of the dump truck 20 including the cargo bed 21 based on the target region image and the depth map. Here, the point cloud data is data configured by representing an image of an object with a plurality of points. The point cloud data generation unit 210 extracts a region of the distance image included in the target region image to generate point cloud data. A known method can be used to generate the point cloud data. The point cloud data generation unit 210 outputs the generated point cloud data to the cargo bed detection processing unit 220.

The cargo bed detection processing unit 220 detects a cargo bed region from the point cloud data. The cargo bed detection processing unit 220 outputs the detected cargo bed region to the data conversion unit 230. Details of the configuration of the cargo bed detection processing unit 220 are explained below.

The data conversion unit 230 converts the cargo bed region into point cloud data. The data conversion unit 230 can also correct the point cloud data. The data conversion unit 230 outputs the point cloud data of the cargo bed region to an external device.

### Configuration of the Cargo Bed Detection Processing Unit

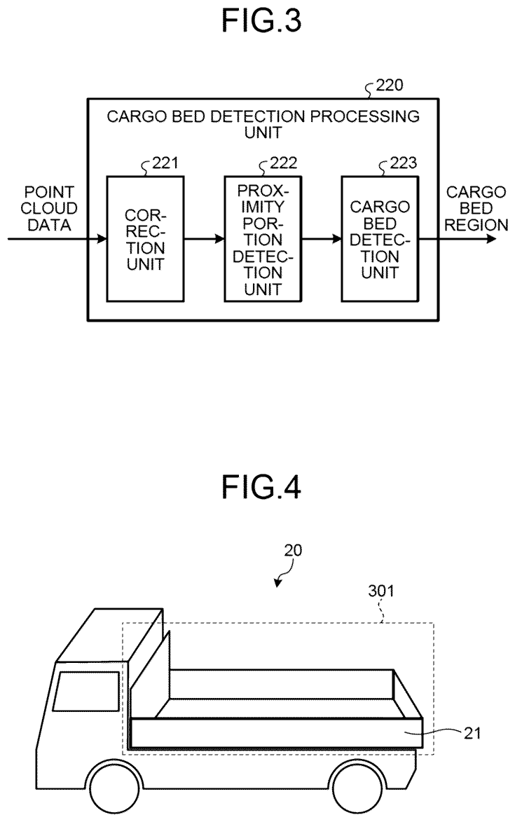

FIG. 3 is a diagram illustrating a configuration example of the cargo bed detection processing unit according to the embodiment of the present disclosure. The figure is a block diagram illustrating a configuration example of the cargo bed detection processing unit 220. The cargo bed detection processing unit 220 includes a correction unit 221, a proximity portion detection unit 222, and a cargo bed detection unit 223.

The correction unit 221 corrects the position of the cargo bed 21 in a distance image. The correction unit 221 corrects point cloud data according to movement of the work device 11. For example, when the turning body 15 of the excavator 10 turns, an angle of the cargo bed 21 with respect to the work device 11 changes and the distance from the cargo bed 21 changes, causing an error. Therefore, the change in the angle of the cargo bed 21 with respect to the work device 11 is corrected to reduce the error. The correction unit 221 outputs the corrected point cloud data to the proximity portion detection unit 222.

The proximity portion detection unit 222 detects a region of the cargo bed 21 in proximity to the work device 11 from the point cloud data. The proximity portion detection unit 222 generates a distance image from the point cloud data. Subsequently, the proximity portion detection unit 222 generates, from the generated distance image, a distance histogram representing a distance as a frequency. A mode value of the distance histogram is assumed to be a distance to a proximity portion which is a region of the cargo bed 21 adjacent to the work device 11, and a region of a distance image in a distance range near the mode value is detected as a distance image of the proximity portion. The proximity portion detection unit 222 outputs the detected distance image to the cargo bed detection unit 223.

The cargo bed detection unit 223 detects an image of the cargo bed 21 from the distance image output from the proximity portion detection unit 222. The cargo bed detection unit 223 detects the cargo bed by generating an image of the cargo bed 21 from the distance image. Note that the cargo bed detection unit 223 is an example of a housing portion detection unit.

The image of the cargo bed 21 can be generated as follows. First, the cargo bed detection unit 223 normalizes the distance with respect to the distance image. This can be performed, for example, by converting the distance data into gradation data having a predetermined bit width. Specifically, the conversion into 8-bit gradation data can be performed by dividing the pixel value of the distance image by the maximum value of the distance and then multiplying the pixel value by the value “255”. Subsequently, the cargo bed detection unit 223 performs edge detection processing on the normalized image to generate an image of an edge of a proximity portion. For example, the Canny method can be applied to the detection of the edge. Subsequently, the cargo bed detection unit 223 performs contour extraction processing on the edge image to generate a contour of the proximity portion. A known method can be applied to the contour extraction processing. Subsequently, the cargo bed detection unit 223 detects a region of the distance image inside the contour using the detected contour as a mask. The cargo bed detection unit 223 outputs the region of the detected distance image as an image of the region of the cargo bed 21.

### Configuration of the Cargo Bed Detection Processing Unit

FIG. 4 is a diagram illustrating an example of a target region image according to the embodiment of the present disclosure. The drawing is a diagram illustrating an example of a target region image output from the target region extraction unit 130. A dotted rectangular region in the image of the dump truck 20 in the figure represents a bounding box of a target region image 301.

### Correction Processing

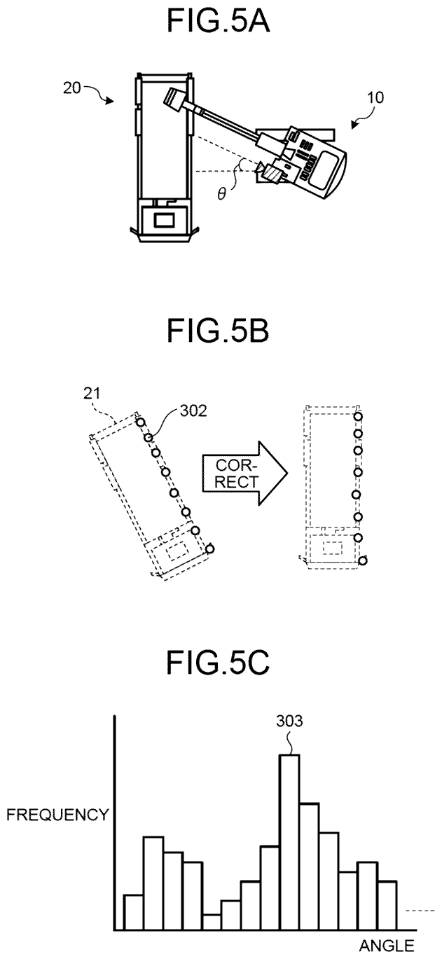

FIGS. 5A to 5C are diagrams illustrating an example of correction according to an embodiment of the present disclosure. The drawing is a diagram illustrating an example of correction in the correction unit 221. FIG. 5A is a diagram illustrating the excavator 10 and the dump truck 20 as viewed from above. The excavator 10 in the figure illustrates an example in which the work device 11 is arranged to be shifted by the angle θ with respect to the normal line direction of the side surface of the cargo bed 21 of the dump truck 20 by the swing of the turning body 15. FIG. 5B is a diagram illustrating correction processing. The point cloud data 302 of the cargo bed 21 is corrected by being rotated by θ.

The detection of the angle θ can be performed as follows. First, a normal vector of each point cloud of the point cloud data is generated. An inner product of the normal vector and a unit vector in a direction parallel to the work device 11 is calculated to generate an angle map. This angle map represents the relative angle of the point of each pixel with the work device 11. An angle histogram is generated based on the angle map. The mode of the angle histogram can be detected as the angle θ. FIG. 5C illustrates an example of the angle histogram. A graph 303 in the figure represents the mode of the angle histogram.

### Detection of Cargo Bed Region

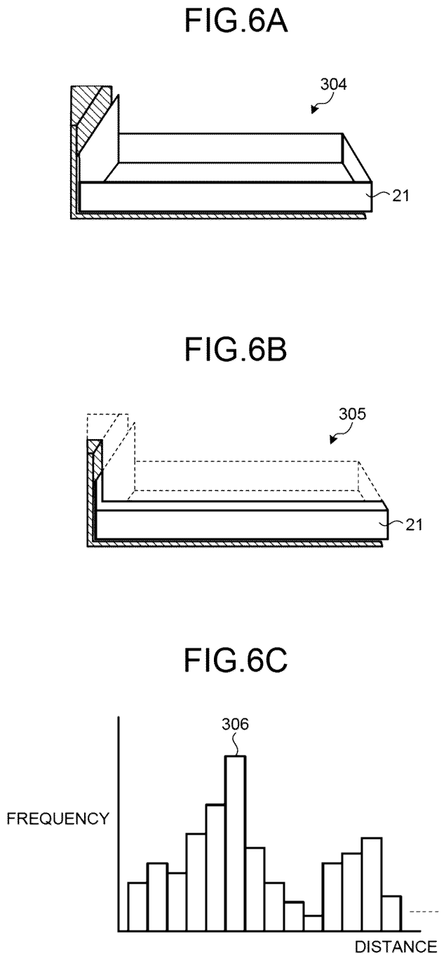

FIGS. 6A to 6C are diagrams illustrating an example of detection of the cargo bed region according to the embodiment of the present disclosure. FIG. 6A is a diagram illustrating an image of point cloud data based on the target region image 301 from the image of FIG. 4. An image 304 in the figure represents point cloud data of the dump truck 20 including the cargo bed 21. A white region in the figure represents the point cloud data of the cargo bed 21. FIG. 6B is a diagram illustrating an image 305 of a proximity portion. The image 305 is an image (distance image) of the proximity portion of the cargo bed 21 generated by the proximity portion detection unit 222. A region indicated by a broken line in the figure represents a region excluded from the image 305. FIG. 6C is a diagram illustrating an example of a distance histogram generated by the proximity portion detection unit 222. A graph 306 illustrated in the figure represents a mode of a distance histogram. This mode can be determined as the distance to a proximity portion of the cargo bed 21. This is because a proximity surface of the cargo bed 21 occupies the largest area in the target region image 301. The proximity portion of the cargo bed 21 can be detected by extracting the distance image using a region having predetermined width with respect to the mode of the distance as a crop range.

### Cargo Bed Region Detection Processing

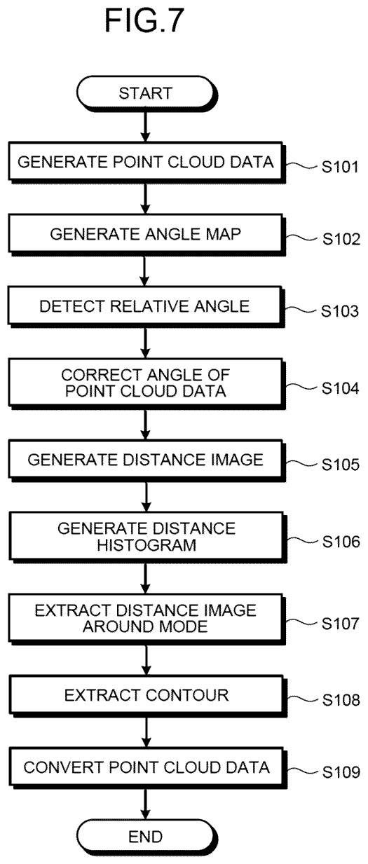

FIG. 7 is a diagram illustrating an example of a processing procedure of cargo bed region detection processing according to the embodiment of the present disclosure. The figure is a flowchart illustrating an example of a processing procedure in the cargo bed region detection unit 200. First, the point cloud data generation unit 210 generates point cloud data (Step S101). Subsequently, the correction unit 221 generates an angle map (Step S102). Subsequently, the correction unit 221 detects a relative angle (Step S103). Subsequently, the correction unit 221 performs angle correction for the point cloud data (Step S104). Subsequently, the proximity portion detection unit 222 generates a distance image (Step S105). Subsequently, the proximity portion detection unit 222 generates a distance histogram (Step S106). Subsequently, the proximity portion detection unit 222 extracts a distance image around the mode of the histogram (Step S107). Subsequently, the cargo bed detection unit 223 extracts a contour of the proximity portion (Step S108). Subsequently, the data conversion unit 230 converts the distance image into point cloud data (Step S109). With the processing explained above, a region of the cargo bed 21 can be detected.

As explained above, the cargo bed region detection unit 200 in the embodiment of the present disclosure detects the distance to the cargo bed 21 from the point cloud data and detects the region of the cargo bed 21. Accordingly, it is possible to simplify extraction processing for an image of the region of the cargo bed 21.

Note that the configuration of the cargo bed region detection unit 200 is not limited to this example. For example, the cargo bed region detection unit 200 can be applied to a work device other than the excavator 10. For example, the cargo bed region detection unit 200 can also be applied to a work device that conveys wood in a forestry use to a cargo bed of a truck. For example, the cargo bed region detection unit 200 can also be applied, for example, when an object is conveyed to a housing portion by a robot arm. The technology of the present disclosure can also be applied to detection of a gripping point of a gripping target object when an object is gripped by a robot arm. Specifically, the cargo bed detection processing unit 220 can detect a gripping point of the gripping target object instead of the cargo bed (the housing portion).

### (Other Modifications)

The detection device 1 of the present embodiment may be implemented by a dedicated computer system or may be implemented by a general-purpose computer system.

For example, a program for executing the operation explained above is stored in a computer-readable recording medium such as an optical disk, a semiconductor memory, a magnetic tape, or a flexible disk and distributed. Then, for example, the control device is configured by installing the program in a computer and executing the processing explained above.

The communication program explained above may be stored in a disk device included in a server device on a network such as the Internet to make it possible to download the communication program to a computer. The functions explained above may be implemented by cooperation of an OS (Operating System) and application software. In this case, a portion other than the OS may be stored in a medium and distributed or the portion other than the OS may be stored in the server device to make it possible to download the portion to the computer.

Among the kinds of processing explained in the embodiment, all or a part of the processing explained as being automatically performed can be manually performed or all or a part of the processing explained as being manually performed can be automatically performed by a publicly-known method. Besides, the processing procedures, the specific names, and the information including the various data and parameters explained in the document and illustrated in the figures can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing processing contents to contradict one another. The order of the steps illustrated the flowchart in the embodiment explained above can be changed as appropriate.

For example, the present embodiments can be implemented as any component configuring a device or a system, for example, a processor functioning as a system LSI (Large Scale Integration) or the like, a module that uses a plurality of processors the like, a unit that uses a plurality of modules or the like, or a set obtained by further adding other functions to the unit (that is, a component as a part of the device).

Note that, in the present embodiments, the system means a set of a plurality of components (devices, modules (components), and the like). It does not matter whether all the components are present in the same housing. Therefore, both of a plurality of devices housed in separate housings and connected via a network and one device in which a plurality of modules is housed in one housing are systems.

For example, the present embodiment can adopt a configuration of cloud computing in which one function is shared and processed by a plurality of devices in cooperation via a network.

Although the embodiments of the present disclosure are explained above, the technical scope of the present disclosure is not limited to the embodiments per se. Various changes can be made without departing from the gist of the present disclosure. Components in different embodiments and modifications may be combined as appropriate.

The processing procedure explained in the embodiments may be regarded as a method including these series of procedures and may be regarded as a program for causing a computer to execute these series of procedures or a recording medium storing the program. As this recording medium, for example, a flexible disk, a CD-ROM (Compact Disc Read Only Memory), an MO (Magnet optical) disk, a DVD (Digital Versatile Disc), a Blu-ray (registered trademark) disc, a magnetic disk, a semiconductor memory, a memory card, and the like can be used.

Note that the effects described in this specification are only illustrations and are not limited.

Other effects may be present.

Note that this technology can also take the following configurations.
(1) A system comprising:
   a correction unit that corrects, in a distance image including a housing portion on which an object is placed by a work device, the distance image according to movement of the work device;
   a proximity portion detection unit that detects a proximity portion of the housing portion based on a distance histogram generated from the corrected distance image; and
   a housing portion detection unit that detects the housing portion based on the detected proximity portion and the distance image.
(2) The system according to the above (1), further comprising
   a point cloud data generation unit that generates point cloud data of the housing portion, wherein
   the correction unit corrects the point cloud data.
(3) The system according to the above (1), further comprising a data conversion unit that converts the detected housing portion into point cloud data.
(4) The system according to any one of the above (1) to (3), wherein the proximity portion detection unit detects the proximity portion based on the distance image of a region near a mode of the distance histogram.
(5) A program comprising:
   a procedure of correcting, in a distance image including a housing portion on which an object is placed by a work device, the distance image according to movement of the work device;
   a procedure of detecting a proximity portion of the housing portion based on a distance histogram generated from the corrected distance image; and
   a procedure of detecting the housing portion based on the detected proximity portion and the distance image.

### REFERENCE SIGNS LIST

1 DETECTION DEVICE
10 EXCAVATOR
11 WORK DEVICE
12 ARM
20 DUMP TRUCK
21 CARGO BED
110 CAMERA
120 DISTANCE MEASURING SENSOR
130 TARGET REGION EXTRACTION UNIT
200 CARGO BED REGION DETECTION UNIT
210 POINT CLOUD DATA GENERATION UNIT
220 CARGO BED DETECTION PROCESSING UNIT
221 CORRECTION UNIT
222 PROXIMITY PORTION DETECTION UNIT
223 CARGO BED DETECTION UNIT
230 DATA CONVERSION UNIT

1. A system comprising:
a correction unit that corrects, in a distance image including a housing portion on which an object is placed by a work device, the distance image according to movement of the work device;
a proximity portion detection unit that detects a proximity portion of the housing portion based on a distance histogram generated from the corrected distance image; and
a housing portion detection unit that detects the housing portion based on the detected proximity portion and the distance image.

2. The system according to claim 1, further comprising
a point cloud data generation unit that generates point cloud data of the housing portion, wherein
the correction unit corrects the point cloud data.

3. The system according to claim 1, further comprising a data conversion unit that converts the detected housing portion into point cloud data.

4. The system according to claim 1, wherein the proximity portion detection unit detects the proximity portion based on the distance image of a region near a mode of the distance histogram.

5. A program comprising:
a procedure of correcting, in a distance image including a housing portion on which an object is placed by a work device, the distance image according to movement of the work device;
a procedure of detecting a proximity portion of the housing portion based on a distance histogram generated from the corrected distance image; and
a procedure of detecting the housing portion based on the detected proximity portion and the distance image.
